(19) United States
(12) Patent Application Publication
(10) Pub. No.: US 2016/0112411 A1
(43) Pub. Date: Apr. 21, 2016

(54) ONE TIME CREDENTIALS FOR SECURE AUTOMATED BLUETOOTH PAIRING

(71) Applicant: NOKIA SOLUTIONS AND NETWORKS OY, ESPOO (FI)

(72) Inventor: Jason SHY, Palatine, IL (US)

(21) Appl. No.: 14/515,193

(22) Filed: Oct. 15, 2014

(51) Int. Cl. H04L 29/06; H04W 12/04; H04W 8/00; H04W 4/00

(52) U.S. Cl. CPC H04L 63/0838; H04W 4/008; H04W 12/04; H04W 8/005

(57) ABSTRACT

Various communication devices may benefit from one time credentials applied in secure automated pairing to improve the security of pairing. For example, certain unattended communication devices capable of implementing mechanisms used for Bluetooth pairing to authenticate with each other may benefit from one time credentials applied in secure automated Bluetooth pairing. A method may include initiating Bluetooth pairing from a first device to a second device. The method may also include querying the second device for a sequence value before pairing is initiated. The method may further include computing a personal identification number/passkey of the first device for the pairing with an arbitrary algorithm. The method may also include pairing, with the personal identification number/passkey, the first device with the second device. The personal identification number/passkey can be determined based on at least one arbitrary shared secret between the first device and the second device, and the sequence value.

### BACKGROUND

1. Field

Various communication devices may benefit from one time credentials applied in secure automated pairing to improve the security of pairing. For example, certain unattended communication devices capable of implementing mechanisms used for Bluetooth pairing to authenticate with each other may benefit from one time credentials applied in secure automated Bluetooth pairing.

2. Description of the Related Art

Generally, Bluetooth is an open standard for short-range radio frequency communication, which is primarily used to establish wireless personal area networks (WPANs). Bluetooth can enable convenient and secure connectivity for an expanding range of devices and services. Bluetooth has been integrated into many types of business and consumer devices, from cars and mobile phones to medical devices and computers and even common eating utensils. For example, among various applications, Bluetooth may be used to connect mobile phones to headsets and hands-free car kits, to connect personal computers to keyboards, mice, and printers, and for data exchange between two mobile phones. Bluetooth may also allow one to share voice, data, music, photos, videos and other information wirelessly between paired devices.

Bluetooth pairing can generally be defined as describing a situation when two Bluetooth-capable devices connect to each other. Connections between Bluetooth-capable devices allow these devices to communicate wireless through short-range, ad hoc networks known as piconets. Piconets can be established dynamically and automatically as Bluetooth-capable devices enter and leave radio proximity, meaning that establishing a connection whenever and wherever is convenient, can be relatively easy.

Each device in a piconet can also simultaneously communicate with up to seven other devices within that single piconet, and each device can also belong to several piconets simultaneously. This means the ways in which Bluetooth devices can connect is almost limitless.

Generally, to securely connect two devices, Bluetooth provides a pairing mechanism. The two devices can be switched into a special mode by the user, and are then able to connect to each other and to establish a link key. The link key can be used to encrypt the traffic subsequently exchanged between the two connected devices. For later connections, the same link key can be reused.

Although there may be certain advantages resulting from the application of Bluetooth technology, Bluetooth pairing has also succumbed to various vulnerabilities. More specifically, Bluetooth pairing can typically be vulnerable to several well-known attacks that can severely limit the cases where Bluetooth pairing can be safely used for authentication of Bluetooth peers without human intervention. For example, Bluetooth technology and associated devices can be susceptible to general wireless networking threats, such as denial of service (DoS) attacks, eavesdropping, man-in-the-middle (MITM) attacks, message modification, and resource misappropriation. They are also threatened by more specific Bluetooth-related attacks that target known vulnerabilities in Bluetooth implementations and specifications. Attacks against improperly secured Bluetooth implementations can provide attackers with unauthorized use of Bluetooth devices and other systems or networks to which the devices are connected.

For example, known attacks on Bluetooth pairing can include sniffing of pairing exchanges for legacy Bluetooth pairing. In this case, an attacker who successfully “sniffs” legacy Bluetooth pairing, can use captured frames to determine the pairing code used. The attacker can also force a re-pairing to improve the chances of sniffing a successful pairing process.

Known attacks on Bluetooth pairing can also include bit by bit discovery of pairing credentials for secure simple pairing (SSP). In this case, every “bad guess” of the attacker can expose one bit of the passkey in use. Thus, through a series of “bad guesses,” the attacker can determine the passkey in use for Bluetooth pairing.

Attacks on Bluetooth pairing can further include merely guessing the personal identification number (PIN)/passkey. As a result, Bluetooth pairing involving a fixed PIN/passkey cannot be safely used to associate devices without human intervention.

In common consumer usage of legacy Bluetooth pairing, weak, static PINs are often used. This exposes the involved devices and users to attacks such as those described above. In an effort to resolve some of the vulnerabilities of Bluetooth pairing, better Bluetooth security can be achieved by following the industry standard recommendations exemplified by the National Institute of Standards and Technology (NIST) guide to Bluetooth Security (NIST Special Publication 800-121 Rev. 1).

As one example for improving Bluetooth security, Bluetooth-capable devices may pair with each other in a location that is secure against sniffing and pairing as infrequently as possible. A drawback from such procedures for real world use cases can be that pairing may need to be performed in public locations. Additionally, devices can be forced to re-pair through corruption of Bluetooth protocol exchanges related to authentication cases.

As another example, Bluetooth-capable devices may use strong, random PINs instead of static PINs for legacy pairing. However, a drawback from using strong random PINs may be that random PINs cannot be re-distributed to devices that need to pair. This usually implies human intervention to either 1) enter the same PIN on both devices, or 2) to read a PIN generated by a first device and enter that PIN on a second device.

As yet another example, Bluetooth-capable devices may use random instead of static passkeys for SSP passkey association. However, a drawback from using random passkeys may be that random passkeys cannot be pre-distributed to the devices that need to pair. This usually implies human intervention to either 1) enter the same passkey on both devices, or 2) for other SSP association modules, to read a passkey generated by a first device and enter/confirm that passkey on a second device.

Additionally, the Bluetooth standard also supports out of band (OOB) distribution of security keys, such as, for example, via near field communication (NFC). However, any OOB mechanism usually must supply its own security measures and may bring its own disadvantages. For example, NFC can rely on NFC-capable hardware, human oversight, and close proximity of the involved devices to prevent eavesdropping.

In order to establish more secure Bluetooth pairing, it may be desirable in some cases to provide a reliable way for Bluetooth devices to securely pair with each other without human intervention.

### SUMMARY

According to certain embodiments, a method can include initiating Bluetooth pairing from a first device to a second device. The method can also include querying the second device for a sequence value before pairing is initiated. The method can further include computing a personal identification number/passkey of the first device for the pairing with an arbitrary algorithm. The method can also include pairing, with the personal identification number/passkey, the first device with the second device. The personal identification number/passkey can be determined based on at least one arbitrary shared secret between the first device and the second device, and the sequence value.

According to other embodiments, a method can include receiving a request to initiate Bluetooth pairing at a first device from a second device. The method can also include receiving a query from the second device for a sequence value before pairing is initiated. The method can further include computing a personal identification number/passkey of the first device for the pairing with an arbitrary algorithm. The method can also include updating, by the first device, the sequence value after an attempt by the second device to pair with the first device. The personal identification number/passkey can be determined based on at least one arbitrary shared secret between the first device and the second device, and the sequence value.

An apparatus, according to certain embodiments, can include at least one processor and at least one memory including computer program code. The at least one memory and the computer program code can be configured to, with the at least one processor, cause the apparatus at least to initiate Bluetooth pairing from a first device to a second device. The at least one memory and the computer program code can also be configured to, with the at least one processor, cause the apparatus at least to query the second device for a sequence value before pairing is initiated. The at least one memory and the computer program code can further be configured to, with the at least one processor, cause the apparatus at least to compute a personal identification number/passkey of the first device for the pairing with an arbitrary algorithm. The at least one memory and the computer program code can also be configured to, with the at least one processor, cause the apparatus at least to pair, with the personal identification number/passkey, the first device with the second device. The personal identification number/passkey can be determined based on at least one arbitrary shared secret between the first device and the second device, and the sequence value.

An apparatus, according to other embodiments, can include at least one processor and at least one memory including computer program code. The at least one memory and the computer program code can be configured to, with the at least one processor, cause the apparatus at least to receive a request to initiate Bluetooth pairing at a first device from a second device. The at least one memory and the computer program code can also be configured to, with the at least one processor, cause the apparatus at least to receive a query from the second device for a sequence value before pairing is initiated. The at least one memory and the computer program code can further be configured to, with the at least one processor, cause the apparatus at least to compute a personal identification number/passkey of the first device for the pairing with an arbitrary algorithm. The at least one memory and the computer program code can also be configured to, with the at least one processor, cause the apparatus at least to update, by the first device, the sequence value after an attempt by the second device to pair with the first device. The personal identification number/passkey can be determined based on at least one arbitrary shared secret between the first device and the second device, and the sequence value.

According to certain embodiments, a computer program can be embodied on a non-transitory computer readable medium. The computer program, when executed by a processor, can cause the processor at least to initiate Bluetooth pairing from a first device to a second device. The computer program, when executed by a processor, can also cause the processor at least to query the second device for a sequence value before pairing is initiated. The computer program, when executed by a processor, can further cause the processor at least to compute a personal identification number/passkey of the first device for the pairing with an arbitrary algorithm. The computer program, when executed by a processor, can also cause the processor at least to pair, with the personal identification number/passkey, the first device with the second device. The personal identification number/passkey can be determined based on at least one arbitrary shared secret between the first device and the second device, and the sequence value.

According to other embodiments, a computer program can be embodied on a non-transitory computer readable medium. The computer program, when executed by a processor, can cause the processor at least to receive a request to initiate Bluetooth pairing at a first device from a second device. The computer program, when executed by a processor, can also cause the processor at least to receive a query from the second device for a sequence value before pairing is initiated. The computer program, when executed by a processor, can further cause the processor at least to compute a personal identification number/passkey of the first device for the pairing with an arbitrary algorithm. The computer program, when executed by a processor, can also cause the processor at least to update, by the first device, the sequence value after an attempt by the second device to pair with the first device. The personal identification number/passkey can be determined based on at least one arbitrary shared secret between the first device and the second device, and the sequence value.

An apparatus, according to certain embodiments, can include means for initiating Bluetooth pairing from a first device to a second device. The apparatus can also include means for querying the second device for a sequence value before pairing is initiated. The apparatus can further include means for computing a personal identification number/passkey of the first device for the pairing with an arbitrary algorithm. The apparatus can also include means for pairing, with the personal identification number/passkey, the first device with the second device. The personal identification number/passkey can be determined based on at least one arbitrary shared secret between the first device and the second device, and the sequence value.

An apparatus according to other embodiments, can include means for receiving a request to initiate Bluetooth pairing at a first device from a second device. The apparatus can also include means for receiving a query from the second device for a sequence value before pairing is initiated. The apparatus can further include means for computing a personal identification number/passkey of the first device for the pairing with an arbitrary algorithm. The apparatus can also include means for updating the sequence value after an attempt by the second device to pair with the first device. The personal identification number/passkey can be determined based on at least one arbitrary shared secret between the first device and the second device, and the sequence value.

A computer program product can, in certain embodiments, encode instructions for performing a process. The process can include initiating Bluetooth pairing from a first device to a second device. The process can also include querying the second device for a sequence value before pairing is initiated. The process can further include computing a personal identification number/passkey of the first device for the pairing with an arbitrary algorithm. The process can also include pairing, with the personal identification number/passkey, the first device with the second device. The personal identification number/passkey can be determined based on at least one arbitrary shared secret between the first device and the second device, and the sequence value.

A computer program product can, in other embodiments, encode instructions for performing a process. The process can include receiving a request to initiate Bluetooth pairing at a first device from a second device. The process can also include receiving a query from the second device for a sequence value before pairing is initiated. The process can further include computing a personal identification number/passkey of the first device for the pairing with an arbitrary algorithm. The process can also include updating, by the first device, the sequence value after an attempt by the second device to pair with the first device. The personal identification number/passkey can be determined based on at least one arbitrary shared secret between the first device and the second device, and the sequence value.

### BRIEF DESCRIPTION OF THE DRAWINGS

For proper understanding of the invention, reference should be made to the accompanying drawings, wherein:

FIG. 1 illustrates a pairing logic used by pairing an initiator and a receiver according to certain embodiments.

FIG. 2 illustrates another pairing logic used by pairing an initiator and a receiver according to certain embodiments.

FIG. 3 illustrates a system according to certain embodiments.

FIG. 4 illustrates a method according to certain embodiments.

FIG. 5 illustrates another method according to certain embodiments.

### DETAILED DESCRIPTION

Certain embodiments may provide an approach to address the above-described security with Bluetooth pairing. For example, certain embodiments may provide a unique credential (PIN/passkey) for each Bluetooth pairing attempt in a unique way that does not depend on human intervention, and does not depend on persistent out of band communication channels.

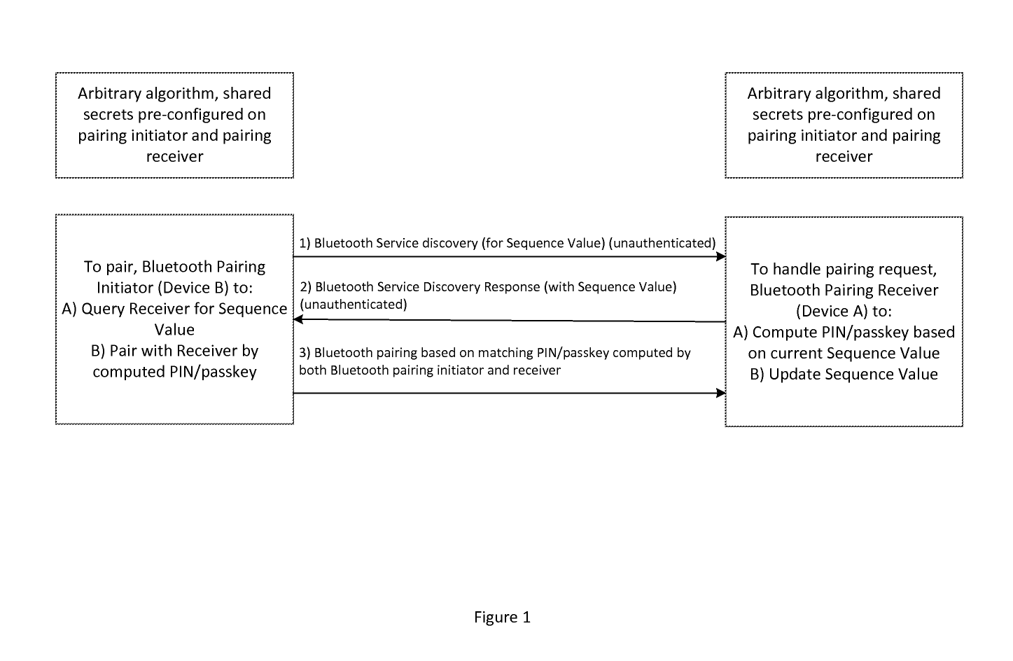

FIG. 1 illustrates a pairing logic used by a pairing initiator (device B) and a receiver (device A), according to certain embodiments. In particular, FIG. 1 shows that prior to pairing, the devices can be pre-configured with an arbitrary shared algorithm to compute each PIN/passkey based on: (1) arbitrary shared secrets; and (2) a sequence value made visible through Bluetooth service discovery protocol (SDP).

According to certain embodiments, the algorithm and secrets may be set once or changed as often as reasonable and feasible for device deployment. The arbitrary shared secrets can be any suitable type of secret. For example, in certain embodiments, the arbitrary shared secrets can be a 64 byte key known by both the client and the server. Additionally, the arbitrary shared secrets can also be site specific or apply to a set of sites.

Furthermore, the arbitrary shared algorithm can be any suitable type of algorithm. For example, in certain embodiments, the arbitrary shared algorithm can be a keyed hash over any site identifying data known to the client and the server.

As shown in FIG. 1, at step 1, to pair with device A, device B can use Bluetooth SDP to query and retrieve the current sequence value from device A. At step 2, device A may respond to device B's query, and via the service discovery response, provide device B with a sequence value. At step 3, device A and device B may be paired together based on a matching PIN/passkey computed by both device A and device B according to the same algorithm and shared secrets in use by device A. In other words, to pair device B with device A, the Bluetooth pairing initiator (device B) can query the receiver (device A) for the sequence value, and pair with device A by the computed PIN/passkey.

Further, to handle the pairing request, device A can similarly compute the PIN/passkey based on the current sequence value, and update the sequence value. According to certain embodiments, device A can change the SDP value, such as, for example, the sequence value, for every pairing attempt it handles. In other words, the sequence value can be updated or changed after handling either a successful or a failed pairing attempt.

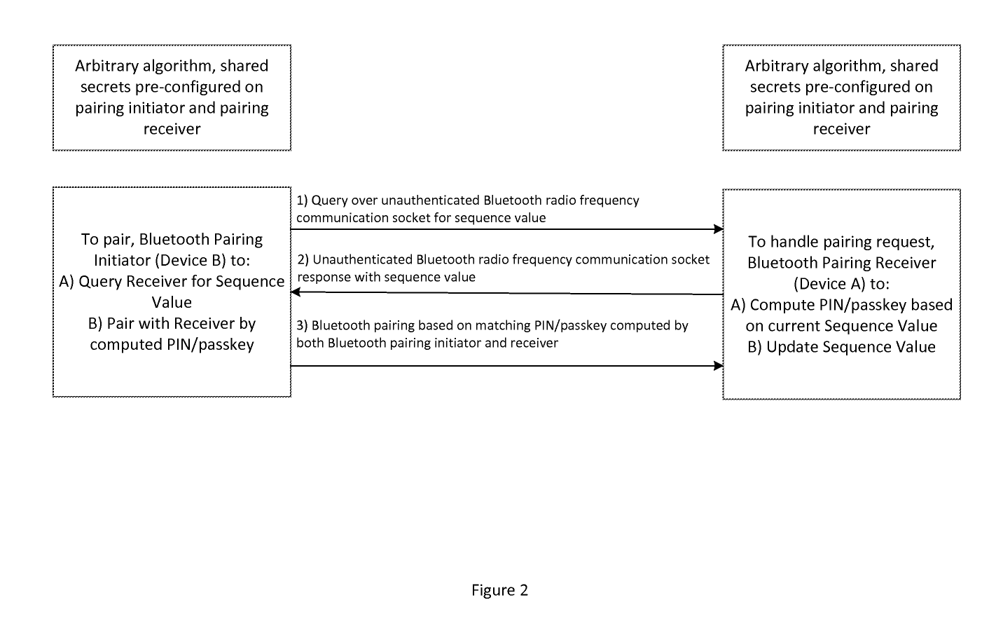

FIG. 2 illustrates a pairing logic used by a pairing initiator (device B) and a receiver (device A), according to another embodiment. In particular, the pairing logic shown in FIG. 2 is similar to that of FIG. 1, except that at step 1, device B may query device A over an unauthenticated Bluetooth radio frequency communication (RFCOMM) socket to retrieve the sequence value from device A. Further, at step 2, device A may respond to device B′s query and provide device B with a sequence value. At step 3, device A and device B may be paired together based on matching PIN/passkey computed by both device A and device B according to the same algorithm and shared secrets in use by device A.

According to Bluetooth standards, both SDP query and unauthenticated RFCOMM socket can be established in advance of pairing, and without the need for credentials. Thus, according to certain embodiments, both SDP query and unauthenticated RFCOMM socket can fit the need for a Bluetooth inband query before authentication is required. Additionally, both query mechanisms can offer similar capabilities, which can expand the range of client devices that can implement the various embodiments described herein.

The changing sequence value may be any value useable by the chosen algorithm. According to the Bluetooth specification, service discovery can be performed without prior authentication. Given the foreknowledge of the target device's Bluetooth device address, certain embodiments may be used to pair with a device regardless of whether its Bluetooth device name is visible to a Bluetooth inquiry response.

Certain embodiments can be implemented between any mix of Bluetooth devices capable of SSP and/or legacy pairing. SSP can simplify the pairing process by providing a number of association models that are flexible in terms of device input/output capability. SSP can also improve security through the addition of Elliptic Curve Diffie-Hellman (ECDH) public key cryptography for protection against passive eavesdropping and MITM attacks during pairing. Further, in legacy pairing, two Bluetooth devices can simultaneously derive link keys when an identical secret PIN can be entered into one or both devices, depending on the configuration and device type.

Better security can be achieved between devices using Bluetooth SSP. However, some operating systems do not allow direct control of the passkey used for SSP. Thus, certain embodiments can still be used with legacy pairing for those cases.

According to certain embodiments, the sequence values to synchronize pairing devices could be communicated in alternate ways. For example, the pairing initiator could publish the sequence values. However, the most reasonable implementation leaves the pairing receiving in control of the sequence values since, for security reasons, the pairing receiver has to ensure the pairing sequence values change for every attempt it handles.

Since the logic is standards compliant, additional related security measures can be employed along with certain embodiments. These additional related security measures may include rate limiting, etc.

Certain embodiments can be useful for automated Bluetooth devices which must pair (authenticate) multiple times or with multiple devices without human interaction. For example, sensors or other communication devices which use Bluetooth may be useful as automated Bluetooth devices. No persistent out of band communication channel is required.

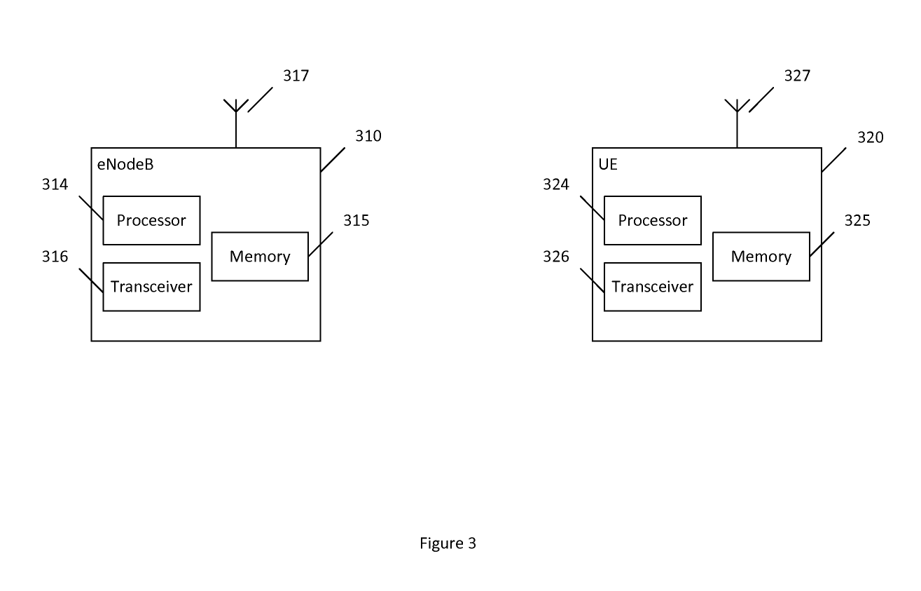

FIG. 3 illustrates a system according to certain embodiments. In one embodiment, a system may include multiple devices, such as, for example, at least one eNodeB 310 or other base station or access point, and at least one user equipment (UE) 320.

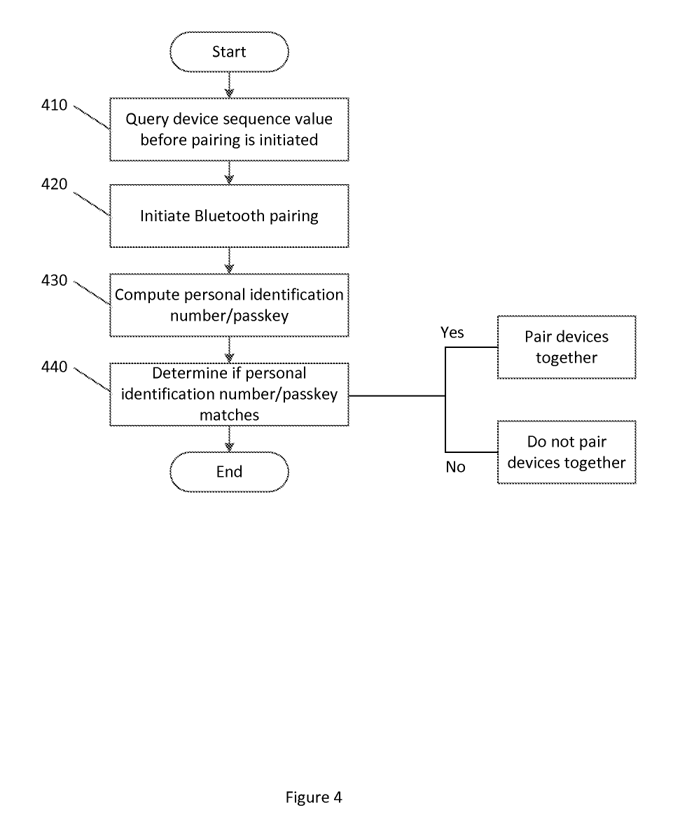

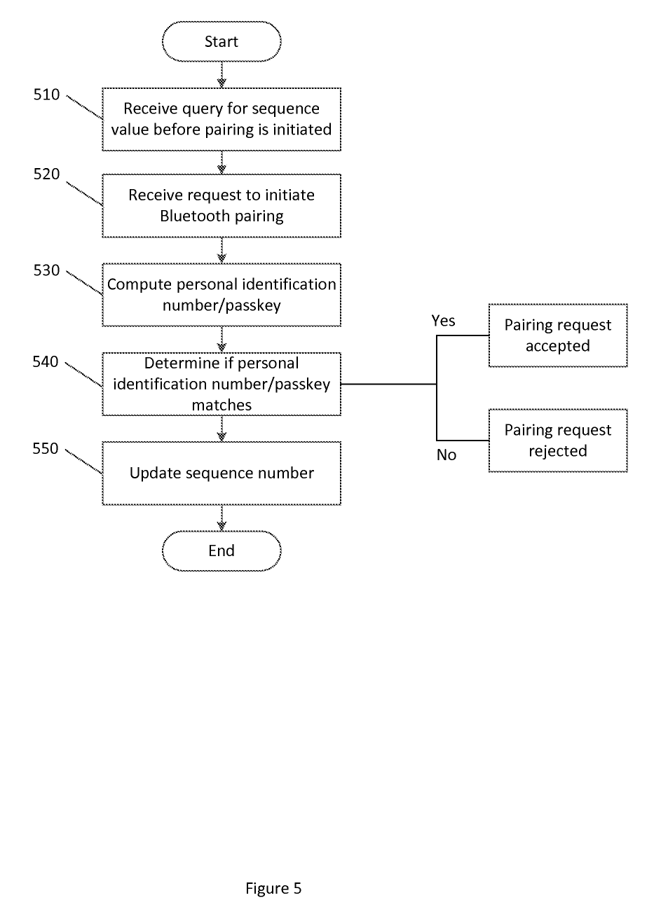

Each of these devices may include at least one processor, respectively indicated as 314 and 324. At least one memory can be provided in each device, and indicated as 315 and 325, respectively. The memory can include computer program instructions or computer code contained therein. The processors 314 and 324, and memories 315 and 325, or a subset thereof, can be configured to provide means corresponding to the various blocks of FIGS. 4 and 5.

As shown in FIG. 3, transceivers 316 and 326 can be provided, and each device may also include an antenna, respectively illustrated as 317 and 327. Transceivers 316 and 326 can each, independently, be a transmitter, a receiver, or both a transmitter and a receiver, or a unit device that is configured both for transmission and reception.

Processors 314 and 324 can be embodied by any computational or data processing device, such as a central processing unit (CPU), application specific integrated circuit (ASIC), or comparable device. The processor can be implemented as a single controller, or a plurality of controllers or processors.

Memories 315 and 325 can be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and computer program instructions can be configured, with the processor for the particular device, to cause a hardware apparatus such as eNodeB 310 and UE 320, to perform any of the processes described herein (see, for example, FIGS. 1, 2, 4 and 5). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 3 illustrates a system including an eNodeB 310 and UE 320, embodiments of the invention may be applicable to other configurations, and configurations involving additional elements. For example, not shown, additional UEs and/or eNodeBs may be present.

FIG. 4 illustrates a method according to certain embodiments. As shown in FIG. 4, a method can include, at 410, querying the second device for a sequence value before pairing is initiated. The method can also include, at 420, initiating Bluetooth pairing from a first device to a second device. The method can further include, at 430, computing a personal identification number/passkey with an arbitrary algorithm. The method can also include, at 440, determining if the PIN/passkey of the first device matches a PIN/passkey of the second device. If the PIN/passkey of the first device matches the PIN/passkey of the second device, then the first device can be paired with the second device. However, if the PIN/passkey of the first device does not match the PIN/passkey of the second device, then the first device is not paired with the second device.

FIG. 5 illustrates another method according to certain embodiments. As shown in FIG. 5, a method can include, at 510, receiving a query from the second device for a sequence value before pairing is initiated. The method can also include, at 520, receiving a request to initiate Bluetooth pairing at a first device from a second device. The method can further include, at 530, computing a personal identification number/passkey for the pairing with an arbitrary algorithm.

The method can also include, at 540, determining if the PIN/passkey match between the first device and the second device. If the PIN/passkey of the first device matches the PIN/passkey of the second device, then the pairing request is accepted. However, if the PIN/passkey of the first device does not match the PIN/passkey of the second device, then the pairing request is rejected.

The method can further include, at 550, updating the sequence value after an attempt to pair with the second device.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

ASIC Application Specific Integrated Circuit

CPU Central Processing Unit

DoS Denial of Service

HDD Hard Disk Drive

MITM Man-in-the-middle

NIST (USA) National Institute of Standards and Technology

NFC Near Field Communication

OOB Out of Band

PIN Personal Identification Number

RAM Random Access Memory

RFCOMM Radio Frequency Communication

SDP Service Discovery Protocol

SSP Secure Simple Pairing

UE User Equipment

WPAN Wireless Personal Area Network

We claim:

1. A method, comprising:
initiating Bluetooth pairing from a first device to a second device;
querying the second device for a sequence value before pairing is initiated;
computing a personal identification number/passkey of the first device for the pairing with an arbitrary algorithm; and
pairing, with the personal identification number/passkey, the first device with the second device,
wherein the personal identification number/passkey is determined based on at least one arbitrary shared secret between the first device and the second device, and the sequence value.

2. The method of claim 1, wherein the first device and the second device share the same arbitrary algorithm and at least one arbitrary shared secret.

3. The method of claim 1, wherein the sequence value is retrieved according to Bluetooth Service Discovery Protocol or by an unauthenticated Bluetooth radio frequency communication socket.

4. The method of claim 1, wherein the first device pairs with the second device regardless of whether a name of the first device is visible to a Bluetooth inquiry response.

5. The method of claim 1, wherein the pairing is implemented between any mix of Bluetooth devices capable of secure simple pairing and/or legacy pairing.

6. The method of claim 1, wherein the arbitrary algorithm and shared secrets are pre-configured on the first device and the second device.

7. A method, comprising:
receiving a request to initiate Bluetooth pairing at a first device from a second device;
receiving a query from the second device for a sequence value before pairing is initiated;
computing a personal identification number/passkey of the first device for the pairing with an arbitrary algorithm; and
updating, by the first device, the sequence value after an attempt by the second device to pair with the first device,
wherein the personal identification number/passkey is determined based on at least one arbitrary shared secret between the first device and the second device, and the sequence value.

8. The method of claim 7, wherein the first device and the second device share the same arbitrary algorithm and at least one arbitrary shared secret.

9. The method of claim 7, wherein the second device pairs with the first device regardless of whether a name of the first device is visible to a Bluetooth inquiry response.

10. The method of claim 7, wherein the arbitrary algorithm and shared secrets are pre-configured on the first device and the second device.

11. An apparatus, comprising:
at least one processor; and
at least one memory including computer program code,
wherein the at least one memory and the computer program code are configured to, with the at least one processor, cause the apparatus at least to
initiate Bluetooth pairing from a first device to a second device;
query the second device for a sequence value before pairing is initiated;
compute a personal identification number/passkey of the first device for the pairing with an arbitrary algorithm; and
pair, with the personal identification number/passkey, the first device with the second device,
wherein the personal identification number/passkey is determined based on at least one arbitrary shared secret between the first device and the second device, and the sequence value.

12. The apparatus of claim 11, wherein the first device and the second device share the same arbitrary algorithm and at least one arbitrary shared secret.

13. The apparatus of claim 11, wherein the sequence value is retrieved according to Bluetooth Service Discovery Protocol or by an unauthenticated Bluetooth radio frequency communication socket.

14. The apparatus of claim 11, wherein the first device pairs with the second device regardless of whether a name of the first device is visible to a Bluetooth inquiry response.

15. The apparatus of claim 11, wherein the pairing is implemented between any mix of Bluetooth devices capable of secure simple pairing and/or legacy pairing.

16. The apparatus of claim 11, wherein the arbitrary algorithm and shared secrets are pre-configured on the first device and the second device.

17. An apparatus, comprising:
at least one processor; and
at least one memory including computer program code,
wherein the at least one memory and the computer program code are configured to, with the at least one processor, cause the apparatus at least to
receive a request to initiate Bluetooth pairing at a first device from a second device;
receive a query from the second device for a sequence value before pairing is initiated;
compute a personal identification number/passkey for the pairing with an arbitrary algorithm; and
update, by the first device, the sequence value after an attempt by the second device to pair with the first device,
wherein the personal identification number/passkey is determined based on at least one arbitrary shared secret between the first device and the second device, and the sequence value.

18. The apparatus of claim 17, wherein the first device and the second device share the same arbitrary algorithm and at least one arbitrary shared secret.

19. The apparatus of claim 17, wherein the second device pairs with the first device regardless of whether a name of the first device is visible to a Bluetooth inquiry response.

20. The apparatus of claim 17, wherein the arbitrary algorithm and shared secrets are pre-configured on the first device and the second device.
